(19) United States
(12) Patent Application Publication
(10) Pub. No.: US 2026/0255096 A1
(43) Pub. Date: Aug. 27, 2026

(54) REAL-TIME TRANSFER FUNCTION ESTIMATION FOR WEARABLE AUDIO DEVICES

(71) Applicant: BOSE CORPORATION, Framingham, MA (US)

(72) Inventors: Aabhas SHARMA, Watertown, MA (US); Emery M. KU, Sudbury, MA (US); Benjamin Isaac RAUBVOGEL, Thornhill (CA); Keith SANTARELLI, Wakefield, MA (US); Brandon Lee OLMOS, Brookline, MA (US)

(21) Appl. No.: 19/062,923

(22) Filed: Feb. 25, 2025

(51) Int. Cl. H04R 1/10; H04R 1/08

(52) U.S. Cl. CPC H04R 1/1041; H04R 1/08; H04R 1/1083; H04R 2460/01; H04R 2460/13

(57) ABSTRACT

Techniques, including wearable audio devices and systems implementing the techniques, for transfer function estimation. Such a wearable audio device may include a driver, a sensor, and one or more processors. The one or more processors may be generally configured, individually or collectively, to: (i) output, using the driver, an output audio signal, (ii) receive, using the sensor, a received audio signal, (iii) estimate, based on the output audio signal and the received audio signal, an audio transfer function at least periodically over a period of time, and (iv) control, based on the estimated audio transfer function, one or more operations of the wearable audio device. The transfer function is generally an audio transfer function when a user is wearing the wearable audio device.

### FIELD

Aspects of the disclosure generally relate to wearable audio devices, and, more particularly, to techniques to enable a wearable audio device to perform real-time transfer function estimation.

### BACKGROUND

Wearable audio devices such as headphones or earbuds are often utilized to enable people to enjoy various forms of entertainment (e.g., music, movies, television shows, sport events, games, podcasts, or other similar entertainment). The wearable audio devices may be controlled with the aim of providing a particularly equalized sound. In some cases, wearable audio devices may utilize active noise reduction (ANR) and may include a transparency (e.g., aware) mode where external sounds are sensed by an external microphone and reproduced to the user. Such wearable audio devices can also be controlled to provide a desired transparency sound profile.

### SUMMARY

All examples and features mentioned below can be combined in any technically possible way.

Aspects of the present disclosure provide a wearable audio device. The wearable audio device generally includes a driver, a sensor, and one or more processors. The one or more processors are generally configured, individually or collectively, to: output, using the driver, an output audio signal, receive, using the sensor, a received audio signal, estimate, based on the output audio signal and the received audio signal, an audio transfer function at least periodically over a period of time, and control, based on the estimated audio transfer function, one or more operations of the wearable audio device.

In aspects, the audio transfer function includes an on-head transfer function.

In aspects, the period of time includes a time between a first power cycle of the wearable audio device and a second power cycle of the wearable audio device.

In aspects, the one or more processors are configured, individually or collectively, to estimate the audio transfer function continuously over the period of time.

In aspects, the output audio signal includes at least one of audio playback content or aware mode content.

In aspects, the one or more processors are configured, individually or collectively, to estimate, based on the output audio signal and the received audio signal, the audio transfer function when a spectral density of the output audio signal is greater than a threshold.

In aspects, the one or more processors are configured, individually or collectively, to control, based on the estimated audio transfer function, the one or more operations of the wearable audio device when a coherence between the output audio signal and the received audio signal is greater than a threshold.

In aspects, the sensor includes a bone conduction sensor.

In aspects, the bone conduction sensor includes one of: an internal microphone disposed inside an ear canal of the user, a microphone facing the ear canal, a voice band accelerometer disposed outside the ear canal, an inertial measurement unit (IMU), or a feedback microphone.

In aspects, the one or more operations include at least one of: the output of the output audio signal, an aware mode of the wearable audio device, an acoustic echo canceller of the wearable audio device, or an active noise reduction mode of the wearable audio device.

In aspects, the one or more processors are configured, individually or collectively, to control the output audio signal by adjusting at least one of an audio limiter, a feedback controller, a feedforward controller, an aware mode controller, a voice filter, a sidetone filter, or an audio equalizer of the wearable audio device.

In aspects, to estimate the audio transfer function, the one or more processors are configured, individually or collectively, to estimate the audio transfer function between the output audio signal and the received audio signal.

In aspects, to estimate the audio transfer function, the one or more processors are configured, individually or collectively, to: form an adjusted audio signal by summing an input audio signal corresponding to the output audio signal and the received audio signal, and estimate the audio transfer function between the output audio signal and the adjusted received audio signal.

In aspects, to estimate the audio transfer function, the one or more processors are configured, individually or collectively, to perform one or more signal processing techniques.

Aspects of the present disclosure are directed to a method. The method generally includes outputting, using a driver included in a wearable audio device, an output audio signal, receive, using a sensor included in the wearable audio device, a received audio signal, estimate, based on the output audio signal and the received audio signal, an audio transfer function at least periodically over a period of time, and control, based on the estimated audio transfer function, one or more operations of the wearable audio device.

In aspects, the period of time includes a time between a first power cycle of the wearable audio device and a second power cycle of the wearable audio device.

In aspects, the output audio signal includes at least one of audio playback content or aware mode content.

Aspects of the present disclosure provide a non-transitory computer-readable medium including computer-executable instructions that, when executed by one or more processors of a wearable audio device, cause the wearable audio device to perform a method. The method generally includes: outputting, using a driver included in a wearable audio device, an output audio signal, receive, using a sensor included in the wearable audio device, a received audio signal, estimate, based on the output audio signal and the received audio signal, an audio transfer function at least periodically over a period of time, and control, based on the estimated audio transfer function, one or more operations of the wearable audio device.

In aspects, the period of time includes a time between a first power cycle of the wearable audio device and a second power cycle of the wearable audio device.

In aspects, the output audio signal includes at least one of audio playback content or aware mode content.

Two or more features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 illustrates an example system, in which aspects of the present disclosure may be implemented.

FIG. 2 illustrates an exemplary wireless audio device, in which aspects of the present disclosure may be implemented.

FIG. 3 illustrates example wearable audio device operations, according to certain aspects of the present disclosure.

FIG. 4 is a block diagram of an example process flow for real-time transfer function estimation during the operations of FIG. 3, according to certain aspects of the present disclosure.

Like numerals indicate like elements.

### DETAILED DESCRIPTION

Certain aspects of the present disclosure provide techniques, including wearable audio devices and systems implementing the techniques, for real-time transfer function estimation. Such techniques may involve (i) estimating a real-time audio transfer function based on an audio signal output at a driver of a wearable audio device and a corresponding audio signal received (e.g., captured) at a sensor (e.g., a bone conduction sensor and/or transducer, such as a feedback microphone) of the wearable audio device and (ii) controlling, based on the estimated audio transfer function, one or more operations of the wearable audio device. In some cases, the audio signal output at the driver may include at least one of audio playback content or aware mode content (e.g., such that the audio transfer function may be estimated between the audio playback content and/or aware mode content and the corresponding audio signal received at the sensor). In this manner, the real-time audio transfer function may be estimated any time while a user is using (and/or wearing) the wearable audio device (e.g., using the device to listen to audio entertainment or reproduced sound from the environment of the user). The real-time audio transfer function estimate may be performed periodically over a period of time (e.g., between power cycles of the wearable audio device), or continuously, such that the one or more operations of the wearable audio device may be continually adapted. In some cases, the audio transfer function may be an on-head transfer function (e.g., a transfer function with a user wearing or having donned the wearable audio device (or at least part of the wearable audio device)).

In some cases, a wearable audio device may utilize an engineered excitation (e.g., an audible sound, such as a ping, chime, or the like) to estimate an audio transfer function for a wearable audio device when a user dons the device. The estimated audio transfer function may be utilized to control various operations of the wearable audio device. For example, the estimated audio transfer function may be used to control active noise reduction (ANR) while playing content on the device, or to control a transparency mode of the device. However, the engineered excitation may be intrusive to the user of the device. Moreover, because the audio transfer function is typically determined using the engineered excitation only a single time when the user dons the device (e.g., to minimize disturbances to the user), the audio transfer function may quickly become outdated as the fit or the seal of the wearable audio device changes (e.g., due to user adjustment and/or gradual shifts over time). As a result, the various operations of the wearable audio device that are controlled based on the audio transfer function may not be properly optimized, leading to performance deterioration for the device. For example, as the fit of the wearable audio device in the ears of a user changes (e.g., becoming looser or tighter), the ANR of the device, which is based on the previously estimated audio transfer function, may be become increasingly sub-optimal.

The present disclosure may enable a wearable audio device to estimate the audio transfer function between an audio signal output at the driver of device and a corresponding audio signal received (e.g., captured) at a sensor of the device in real-time and using audio playback content or aware mode content. In this manner, the operations of the wearable audio device that rely on the estimated audio transfer function may be continually adapted to provide an optimized experience for the user of the wearable audio device. In some cases, the real-time estimated audio transfer function may be used to control (e.g., adjust) the audio signal output at the drive, an aware mode of the device, an acoustic echo canceller of the device, and/or an ANR mode of the device. For example, the real-time estimated audio transfer function may be used to control an audio limiter, a feedback controller, a feedforward controller, an aware mode controller, a voice filter, a sidetone filter, an ANR controller, an audio equalizer, and/or any other controllers or filters of the wearable audio device. In addition, the audio transfer function may be estimated using audio playback content (e.g., music, movies, television shows, sport events, games, podcasts, or other similar entertainment) or aware mode content (e.g., sounds from the environment of the user), as opposed to an engineered excitation that is often intrusive to the user.

### An Example System

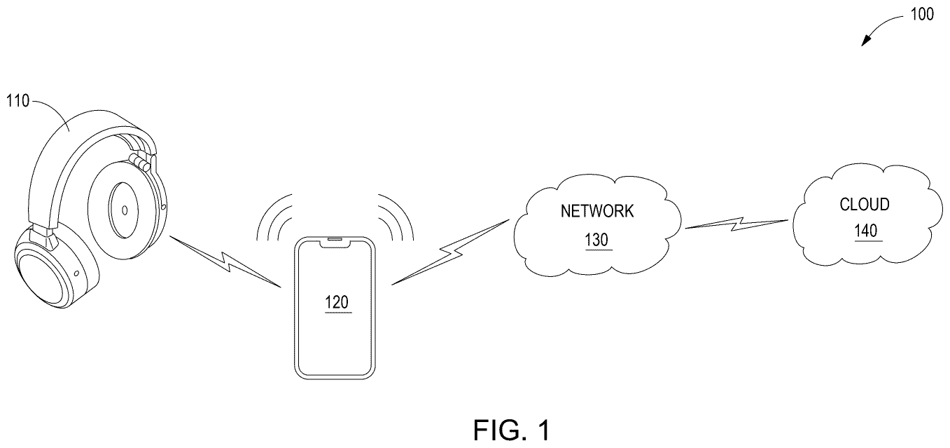

FIG. 1 illustrates an example system 100, in which aspects of the present disclosure may be implemented. As shown, system 100 includes one or more sound processing and playback devices 110 (e.g., a wireless audio device, such as a wearable device as shown in FIG. 1) communicatively coupled with a source device 120 (e.g., a computing device or user device, such as a smartphone, tablet, computer, television, and the like). Throughout the present disclosure, the sound processing and playback device 110 may be referred to simply as the wearable device 110. The wearable device 110 may be configured to be worn by a user and may be a headset that includes two or more speakers and two or more sensors, as illustrated in FIG. 1. The source device 120 is illustrated as a smartphone or a tablet computer wirelessly paired with the wearable device 110. At a high level, the wearable device 110 may play audio content transmitted from the source device 120. The user may use the graphical user interface (GUI) on the source device 120 to select the audio content and/or adjust settings of the wearable device 110. The wearable device 110 provides soundproofing, active noise cancellation, and/or other audio enhancement features to play the audio content transmitted from the source device 120.

In certain aspects, the wearable device 110 includes voice activity detection (VAD) circuitry capable of detecting the presence of speech signals (e.g., human speech signals) in a sound signal received by sensors (not illustrated) of the wearable device 110. For instance, the sensors of the wearable device 110 may be implemented as microphones and may receive ambient and external sounds in the vicinity of the wearable device 110, including speech uttered by the user. The sound signal received by the sensors may have the speech signal mixed in with other sounds in the vicinity of the wearable device 110. Using the VAD, the wearable device 110 may detect and extract the speech signal from the received sound signal. In certain aspects, the VAD circuitry may be used to detect and extract speech uttered by the user in order to facilitate a voice call, voice chat between the user and another person, or voice commands for a virtual personal assistant (VPA), such as a cloud based VPA. In some cases, detections or triggers can include self-VAD (only starting up when the user is speaking, regardless of whether others in the area are speaking), active transport (sounds captured from transportation systems), head gestures, buttons, computing device based triggers (e.g., pause/un-pause from the phone), changes with input audio level, and/or audible changes in environment, among others. The voice activity detection circuitry may run or assist running the phase reconstruction disclosed herein.

In certain aspects, the wearable device 110 includes speaker identification circuitry capable of detecting an identity of a speaker to which a detected speech signal relates to. For example, the speaker identification circuitry may analyze one or more characteristics of a speech signal detected by the VAD circuitry and determine that the user of the wearable device 110 is the speaker. In certain aspects, the speaker identification circuitry may use any of the existing speaker recognition methods and related systems to perform the speaker recognition.

The wearable device 110 further includes hardware and circuitry including processor(s)/processing system and memory configured to implement one or more sound management capabilities or other capabilities including, but not limited to, noise canceling circuitry (not shown) and/or noise masking circuitry (not shown), body movement detecting devices/sensors and circuitry (e.g., one or more accelerometers, one or more gyroscopes, one or more magnetometers, etc.), geolocation circuitry and other sound processing circuitry. The noise cancelling circuitry is configured to reduce unwanted ambient sounds external to the wearable device 110 by using active noise cancelling (also known as active noise reduction). The sound masking circuitry is configured to reduce distractions by playing masking sounds via the speakers of the wearable device 110. The movement detecting circuitry is configured to use devices/sensors such as an accelerometer, gyroscope, magnetometer, and the like to detect whether the user wearing the wearable device 110 is moving (e.g., walking, running, in a moving mode of transport, etc.) or is at rest and/or the direction the user is looking or facing. The movement detecting circuitry may also be configured to detect a head position of the user for use in determining an event, as will be described herein, as well as in augmented reality (AR) applications where an AR sound is played back based on a direction of gaze of the user.

In certain aspects, the wearable device 110 is wirelessly connected to the source device 120 using one or more wireless communication methods including, but not limited to, Bluetooth, Wi-Fi, Bluetooth Low Energy (BLE), other radio frequency (RF) based techniques, and the like. In certain aspects, the wearable device 110 includes a transceiver that transmits and receives data via one or more antennae in order to exchange audio data and other information with the source device 120.

In certain aspects, the wearable device 110 includes communication circuitry capable of transmitting and receiving audio data and other information from the source device 120. The wearable device 110 also includes an incoming audio buffer, such as a render buffer, that buffers at least a portion of an incoming audio signal (e.g., audio packets) in order to allow time for retransmissions of any missed or dropped data packets from the source device 120. For example, when the wearable device 110 receives Bluetooth transmissions from the source device 120, the communication circuitry typically buffers at least a portion of the incoming audio data in the render buffer before the audio is actually rendered and output as audio to at least one of the transducers (e.g., audio speakers) of the wearable device 110. This is done to ensure that even if there are RF collisions that cause audio packets to be lost during transmission, there is time for the lost audio packets to be retransmitted by the source device 120 before the lost audio packets have been rendered by the wearable device 110 for output by one or more acoustic transducers of the wearable device 110.

The wearable device 110 is illustrated as over-the-head headphones; however, the techniques described herein apply to other wearable devices, such as wearable audio devices, including any audio output device that fits around, on, in, or near an ear (including open-ear audio devices worn on the head or shoulders of a user) or other body parts of a user, such as head or neck. The wearable device 110 may take any form, wearable or otherwise, including standalone devices (including automobile speaker system), stationary devices (including portable devices, such as battery powered portable speakers), headphones (including over-ear headphones, on-ear headphones, in-ear headphones), earphones, earpieces, headsets (including virtual reality (VR) headsets and AR headsets), goggles, headbands, earbuds, armbands, sport headphones, neckbands, hearing aids, or eyeglasses. In certain aspects, the wearable device 110 may be implemented as a banded headset with two cups each configured to deliver audio output.

In certain aspects, the wearable device 110 is connected to the source device 120 using a wired connection, with or without a corresponding wireless connection. The source device 120 may be a smartphone, a tablet computer, a laptop computer, a digital camera, or other computing device that connects with the wearable device 110. As shown, the source device 120 can be connected to a network 130 (e.g., the Internet) and may access one or more services over the network. As shown, these services can include one or more cloud 140 services.

In certain aspects, the source device 120 can access a cloud server in the cloud 140 over the network 130 using a mobile web browser or a local software application or “app” executed on the source device 120. In certain aspects, the software application or “app” is a local application that is installed and runs locally on the source device 120. In certain aspects, a cloud server accessible on the cloud 140 includes one or more cloud applications that are run on the cloud server. The cloud application may be accessed and run by the source device 120. For example, the cloud application can generate web pages that are rendered by the mobile web browser on the source device 120. In certain aspects, a mobile software application installed on the source device 120 or a cloud application installed on a cloud server, individually or in combination, may be used to implement the techniques for low latency Bluetooth communication between the source device 120 and the wearable device 110 in accordance with aspects of the present disclosure. In certain aspects, examples of the local software application and the cloud application include a gaming application, an audio AR or VR application, and/or a gaming application with audio AR or VR capabilities. The source device 120 may receive signals (e.g., data and controls) from the wearable device 110 and send signals to the wearable device 110.

### An Example Wearable Device

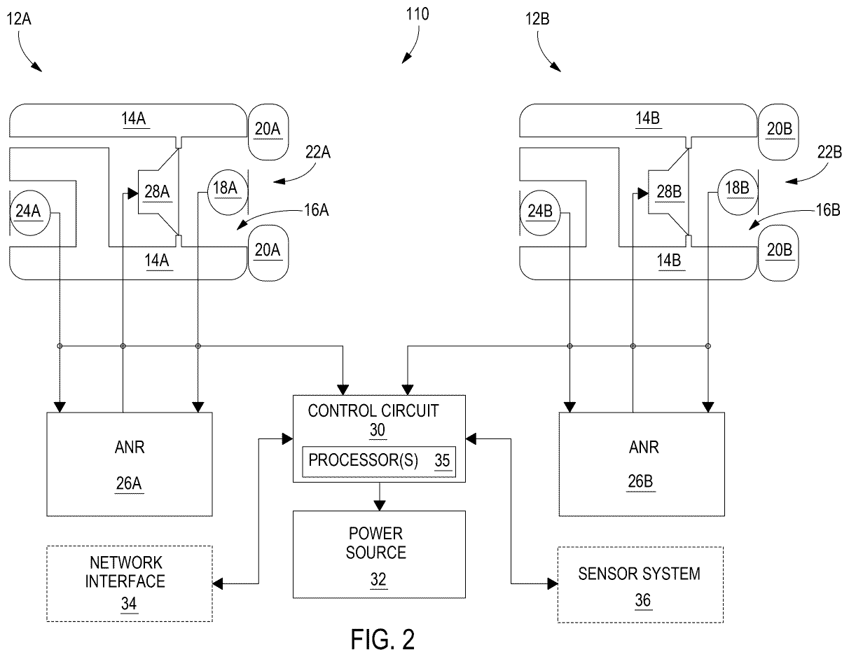

FIG. 2 illustrates an exemplary wearable device 110 and some of its components, in which aspects of the present disclosure may be implemented. Other components may be inherent in the wearable device 110 and not shown in FIG. 2. As shown, the wearable device 110 includes two earpieces 12A and 12B, each configured to direct sound towards an ear of the user. Reference numbers appended with an “A” or a “B” indicate a correspondence of the identified feature with a particular one of the earpieces 12 (e.g., a left earpiece 12A and a right earpiece 12B). Each earpiece 12 includes a casing 14 that defines a cavity 16. In some examples, one or more inner (e.g., internal) sensors 18 (e.g., inner microphone(s)) may be disposed within cavity 16. In implementations where the wearable device 110 is ear-mountable, an ear coupling 20 (e.g., an ear tip or ear cushion) may be attached to the casing 14 and surround an opening to the cavity 16. A passage 22 is formed through the ear coupling 20 and communicates with the opening to the cavity 16. In some examples, one or more outer sensors 24 are disposed on the casing in a manner that permits acoustic coupling to the environment external to the casing. The inner sensor(s) 18 and the outer sensor(s) 24 may each be implemented and/or referred to as a microphone, an accelerometer, and/or an inertial measurement unit (IMU).

In implementations that include active noise reduction (ANR) (which may include active noise cancellation (ANC) or controllable noise canceling (CNC)) and/or transparency (e.g., aware) mode operation (where environmental sound is sensed and then reproduced to the user so the user is more environmentally aware and can hear others speaking and the like), the inner sensor(s) 18 may be an internal microphone(s) or feedback microphone(s) and the outer sensor(s) 24 may be feedforward microphone(s). In such implementations, each earpiece 12 includes an ANR circuit 26 that is in communication with the inner sensor(s) 18 and the outer sensor(s) 24. The ANR circuit 26 receives an inner signal generated by the inner sensor(s) 18 and an outer signal generated by the outer sensor(s) 24 and performs an ANR process for the corresponding earpiece 12. The process includes providing a signal to an electroacoustic transducer 28 (e.g., speaker) disposed in the cavity 16 to generate an anti-noise acoustic signal that reduces or substantially prevents sound from one or more acoustic noise sources that are external to the earpiece 12 from being heard by the user. In addition to providing an anti-noise acoustic signal, the electroacoustic transducer 28 may utilize its sound-radiating surface for providing an audio output for playback (e.g., for a continuous audio feed).

In certain aspects, the wearable device 110 may also include a control circuit 30. The control circuit 30 is in communication with the inner sensor(s) 18, outer sensor(s) 24, and electroacoustic transducers 28, and receives the inner and/or outer microphone signals. In some cases, the control circuit 30 includes one or more microcontroller(s) or processor(s) 35, including for example, a digital signal processor (DSP) and/or an advanced reduced instruction set computer (RISC) machine (ARM) chip. In some cases, the microcontroller(s)/processor(s) (or simply, processor(s)) 35 may include multiple chipsets for performing distinct functions. For example, the processor(s) 35 may include a DSP chip for performing music and voice related functions, and a co-processor such as an ARM chip (or chipset) for performing sensor related functions. In certain aspects, the control circuit 30 may be configured to calculate an equalization (EQ) controller, an ANR controller, a transparency mode controller, and/or other controllers (and/or filters) used to control various operations of the wearable device 110 based on an estimated audio transfer function between the electroacoustic transducer 28 and the inner sensor(s) 18.

The control circuit 30 may also include analog to digital converters for converting the inner signals from the two inner sensors 18 and/or the outer signals from the two outer sensors 24 to digital format. In response to the received inner and/or outer microphone signals, the control circuit 30 (including processor(s) 35) may take various actions. For example, audio playback may be initiated, paused, or resumed, a notification to a user (e.g., wearer) may be provided or altered, and a device (e.g., a cellular phone, a handheld device, a wireless device, a laptop computer, a tablet, a smartphone, an Internet of things (IoT) device, a wearable device, an AR device, a VR device, etc.) in communication with the wearable device 110 may be controlled. The wearable device 110 may also include a power source 32. The control circuit 30 and power source 32 may be in one or both of the earpieces 12 or may be in a separate housing in communication with the earpieces 12. The wearable device 110 may also include a network interface 34 to provide communication between the wearable device 110 and one or more audio sources or other personal audio devices (e.g., source device 120 as illustrated in FIG. 1). The network interface 34 may be wired (e.g., Ethernet) or wireless (e.g., employ a wireless communication protocol such as IEEE 802.11, Bluetooth, Bluetooth Low Energy (BLE), or other local area network (LAN) or personal area network (PAN) protocols).

The network interface 34 is shown in phantom, as portions of the network interface 34 may be located remotely from the wearable device 110. The network interface 34 may provide for communication between the wearable device 110, audio sources, and/or other networked (e.g., wireless) speaker packages and/or other audio playback devices via one or more communications protocols. The network interface 34 may provide either or both of a wireless interface and a wired interface. The wireless interface may allow the wearable device 110 to communicate wirelessly with other devices in accordance with any communication protocol noted herein. In some particular cases, a wired interface may be used to provide network interface functions via a wired (e.g., Ethernet) connection.

In certain aspects, the network interface 34 may also include one or more network media processor(s) for supporting, e.g., Apple AirPlay® (a proprietary protocol stack/suite developed by Apple Inc., with headquarters in Cupertino, Calif., that allows wireless streaming of audio, video, and photos, together with related metadata between devices) or other known wireless streaming services (e.g., an Internet music service such as: Pandora®, a radio station provided by Pandora Media, Inc. of Oakland, Calif., USA; Spotify®, provided by Spotify USA, Inc., of New York, N.Y., USA); or vTuner®, provided by vTuner.com of New York, N.Y., USA); and network-attached storage (NAS) devices). For example, when a user connects an AirPlay® enabled device, such as an iPhone or iPad device, to the network, the user may then stream music to the network connected audio playback devices via Apple AirPlay®. Notably, the audio playback device can support audio-streaming via AirPlay® and/or DLNA's UPnP protocols, and all integrated within one device. Other digital audio coming from network packets may come straight from the network media processor(s) through (e.g., through a USB bridge) to the control circuit 30. As noted herein, in some cases, the control circuit 30 may include one or more processor(s) and/or microcontroller(s) (simply, “processor(s)” 35), which can include decoders, digital signal processors (DSPs) hardware/software, ARM processor(s) hardware/software, etc. for playing back (rendering) audio content at electroacoustic transducers 28. In some cases, the network interface 34 may also include Bluetooth circuitry for Bluetooth applications (e.g., for wireless communication with a Bluetooth enabled audio source such as a smartphone or tablet). In operation, streamed data can pass from the network interface 34 to the control circuit 30, including the processor(s) or microcontroller(s) (e.g., processor(s) 35). The control circuit 30 may execute instructions (e.g., for performing, among other things, digital signal processing, decoding, and equalization functions), including instructions stored in a corresponding memory (which may be internal to control circuit 30 or accessible via network interface 34 or other network connection (e.g., cloud-based connection). The control circuit 30 may be implemented as a chipset of chips that include separate and multiple analog and digital processors. The control circuit 30 may provide, for example, for coordination of other components of the wearable device 110, such as control of user interfaces (not shown) and applications run by the wearable device 110.

In addition to a processor(s) and/or microcontroller(s), control circuit 30 may also include one or more digital-to-analog (D/A) converters for converting the digital audio signal to an analog audio signal. This audio hardware may also include one or more amplifiers which provide amplified analog audio signals to the electroacoustic transducer(s) 28, which each include a sound-radiating surface for providing an audio output for playback. In addition, the audio hardware may include circuitry for processing analog input signals to provide digital audio signals for sharing with other devices.

The memory in control circuit 30 may include, for example, flash memory and/or non-volatile random access memory (NVRAM). In some implementations, instructions (e.g., software) are stored in an information carrier. The instructions, when executed by one or more processing devices (e.g., the processor(s) or microcontroller(s) in control circuit 30), perform one or more processes, such as those described elsewhere herein. The instructions can also be stored by one or more storage devices, such as one or more (e.g., non-transitory) computer or machine-readable mediums (for example, the memory, or memory on the processor(s)/microcontroller(s)). As described herein, the control circuit 30 (e.g., memory, or memory on the processor(s)/microcontroller(s)) may include a control system including instructions for controlling directional audio selection functions according to various particular implementations. It is understood that portions of the control circuit 30 (e.g., instructions) could also be stored in a remote location or in a distributed location and could be fetched or otherwise obtained by the control circuit 30 (e.g., via any communications protocol described herein) for execution. The instructions may include instructions for controlling device functions based upon detected don/doff events (i.e., the software modules include logic for processing inputs from a sensor system to manage audio functions), as well as digital signal processing and equalization.

The wearable device 110 may also include a sensor system 36 coupled with control circuit 30 for detecting one or more conditions of the environment proximate the wearable device 110. The sensor system 36 may include inner sensor(s) 18 and/or outer sensors 24, sensors for detecting inertial conditions at the personal audio device, and/or sensors for detecting conditions of the environment proximate the wearable device 110, as described herein. Sensor system 36 may also include one or more proximity sensors, such as a capacitive proximity sensor or an IR sensor, and/or one or more optical sensors.

The sensors may be on-board the wearable device 110 or may be remote or otherwise wirelessly (or hard-wired) connected to the wearable device 110. As described further herein, sensor system 36 may include a plurality of distinct sensor types for detecting proximity information, inertial information, environmental information, or commands at the wearable device 110. In particular implementations, sensor system 36 may enable detection of user movement, including movement of a user's head or other body part(s). Portions of sensor system 36 may incorporate one or more movement sensors, such as accelerometers, gyroscopes and/or magnetometers and/or a single IMU having three-dimensional (3D) accelerometers, gyroscopes and a magnetometer.

In various implementations, the sensor system 36 can be located at the wearable device 110 (e.g., where a proximity sensor is physically housed in the wearable device 110). In some examples, the sensor system 36 is configured to detect a change in the position of the wearable device 110 relative to the user's head (e.g., detect the device operating state). Data indicating the change in the position of the wearable device 110 may be used to trigger a command function, such as activating an operating mode of the wearable device 110, modifying playback of audio at the wearable device 110 (e.g., by modifying the audio, noise cancellation (e.g., ANC), or transparency of the wearable device), or controlling a power function of the wearable device 110.

The sensor system 36 may also include one or more interface(s) for receiving commands at the wearable device 110. For example, sensor system 36 may include an interface permitting a user to initiate functions of the wearable device 110. In a particular example implementation, the sensor system 36 may include, or be coupled with, a capacitive touch interface for receiving tactile commands on the wearable device 110.

In other implementations, as illustrated in the phantom depiction in FIG. 2, one or more portions of the sensor system 36 may be located at another device capable of indicating movement and/or inertial information about the user of the wearable device 110. For example, in some cases, the sensor system 36 may include an IMU physically housed in a hand-held device such as a smart device (e.g., smart phone, tablet, etc.) a pointer, or in another wearable audio device. In particular example implementations, at least one of the sensors in the sensor system 36 may be housed in a wearable audio device distinct from the wearable device 110, such as where wearable device 110 includes headphones and an IMU is located in a pair of glasses, a watch, or other wearable electronic device.

In certain aspects, the control circuit 30 is in communication with the inner sensor(s) 18 and receives the two inner signals. Alternatively, the control circuit 30 may be in communication with the outer sensors 24 and receive the two outer signals. In another alternative, the control circuit 30 may be in communication with both the inner sensor(s) 18 and outer sensors 24 and receives the two inner and two outer signals. It should be noted that in some implementations, there may be multiple inner and/or outer microphones in each earpiece 12. As noted herein, the control circuit 30 may include one or more microcontroller(s) or processor(s) having a DSP and the inner signals from the two inner sensor(s) 18 and/or the outer signals from the two outer sensors 24 are converted to digital format by analog to digital converters. In response to the received inner and/or outer signals, the control circuit 30 may take various actions. For example, the power supplied to the wearable device 110 may be reduced upon a determination that one or both earpieces 12 are off-head. In another example, full power may be returned to the wearable device 110 in response to a determination that at least one earpiece becomes on head. Other aspects of the wearable device 110 may be modified or controlled in response to determining that a change in the operating state of the earpiece 12 has occurred. For example, ANR functionality may be enabled or disabled, audio playback may be initiated, paused or resumed, a notification to a wearer may be altered, and a device (e.g., a cellular phone, a handheld device, a wireless device, a laptop computer, a tablet, a smartphone, an Internet of things (IoT) device, a wearable device, an AR device, a VR device, etc.) in communication with the wearable device 110 may be controlled. As illustrated, the control circuit 30 generates a signal that is used to control a power source 32 for the wearable device 110. The control circuit 30 and power source 32 may be in one or both of the earpieces 12 or may be in a separate housing in communication with the earpieces 12.

### Example Operations for Transfer Function Estimation

Certain aspects of the present disclosure provide techniques, including wearable audio devices and systems implementing the techniques, for real-time transfer function estimation. Such techniques may involve (i) performing a real-time estimate of an audio transfer function based on an audio signal output at the driver of device and a corresponding audio signal received (e.g., captured) at a sensor of the device in real-time, and (ii) controlling, based on the estimated audio transfer function, one or more operations of the wearable audio device. In this manner, the operations of the wearable audio device that rely on the estimated audio transfer function may be continually adapted to provide an optimized experience for the user of the wearable audio device even as the fit or seal of the device changes over time. In addition, the audio transfer function may be estimated using audio content (e.g., music, movies, television shows, sport events, games, podcasts, or other similar entertainment) or aware mode content (e.g., sounds from the environment of the user) being played on the wearable audio device.

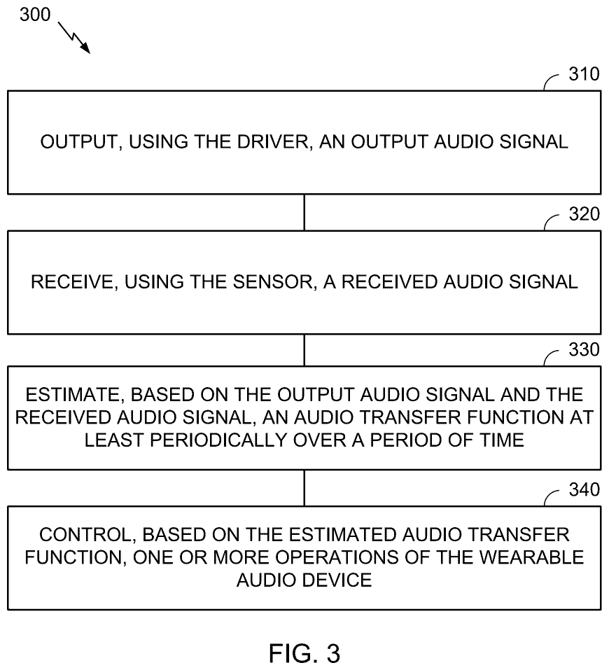

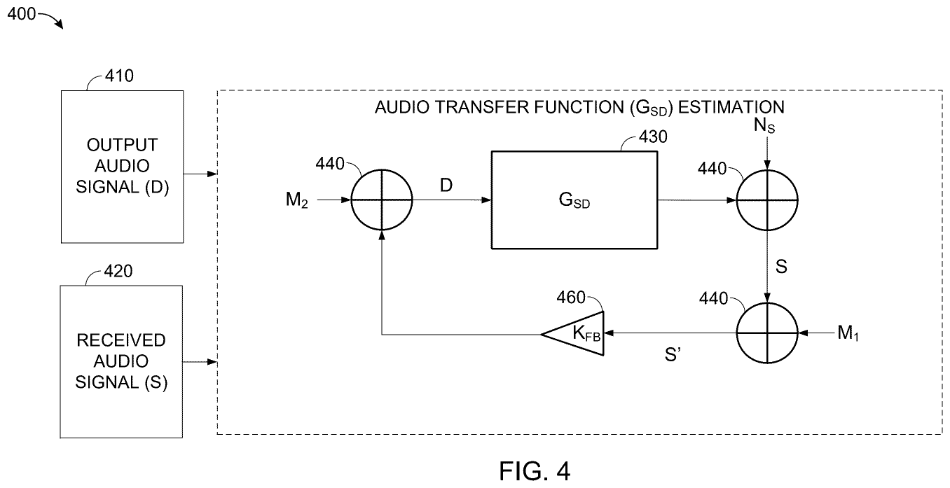

FIG. 3 illustrates example wearable audio device operations 300, according to certain aspects of the present disclosure. FIG. 4 is a block diagram of an example process flow 400 for transfer function estimation during the operations 300 of FIG. 3, according to certain aspects of the present disclosure. Therefore, FIGS. 3 and 4 are herein described together for clarity. The operations 300 and the process flow 400 may be performed by a wearable audio device (e.g., the wearable device 110 of FIG. 1 and FIG. 2, which may be referred to herein simply as the “device”), or by a control circuit (e.g., control circuit 30) of the device (e.g., using one or more processors, individually or collectively, included in the control circuit 30). The operations 300 and the process flow 400 may be utilized by the wearable audio device continuously, periodically, or selectively, as will be described herein. In some cases, the operations 300 may be triggered, for example, when the fit or the seal of the wearable audio device changes (e.g., due to user adjustment and/or gradual shifts over time). For example, when the fit and/or seal of the wearable audio device changes from a baseline measurement (e.g., measured when the user dons the device) by a certain level, the operations 300 may be triggered.

The operations 300 may include, at block 310, outputting, using a driver (e.g., electroacoustic transducer 28) included in the wearable audio device, an output audio signal 410 (labeled “d”).

At block 320, the operations 300 may include receiving, using a sensor (e.g., inner sensor(s) 18) included in the wearable audio device, a received audio signal 420 (labeled“s”). The sensor may be implemented by, for example, a bone conduction sensor and/or transducer (e.g., an internal microphone disposed inside an ear canal of a user of the device, an internal microphone facing the ear canal, a voice band accelerometer disposed outside the ear canal, a feedback microphone, an inside the earphone microphone, a vibration sensor (accelerometer or otherwise)), an inertial measurement unit (IMU), and the like, which may all be referred to herein simply as sensors).

At block 330, the operations 300 may include estimating, based on the output audio signal 410 and the received audio signal 420, an audio transfer function 430 (labeled “G_{sd}”) at least periodically over a period of time. The audio transfer function 430 may be an audio transfer function of the wearable audio device when the user is wearing the device, and may be (or be referred to as) an on-head audio transfer function. The audio transfer function 430 may be the transfer function between the output audio signal 410 (or playback content used to produce the output audio signal 410) and the received audio signal 420. In some cases, the audio transfer function 430 may be between other sources and targets on the wearable audio device. For example, the audio transfer function 430 may be between other one or more inner sensors (e.g., inner sensor(s) 18) included in the wearable audio device and one or more outer sensors (e.g., outer sensor(s) 24) in the device.

In certain aspects, the audio transfer function 430 may be estimated at block 330 continuously over the period of time. In other aspects, the audio transfer function 430 may be estimated at block 330 periodically over a period of time. The period of time may include, for example, a time between a first power cycle of the wearable audio device and a second power cycle of the wearable audio device. In this manner, the audio transfer function 430 may be estimated multiple times while the wearable audio device is powered on. In some cases, the period of time may be the period of time used to collect enough information for the audio transfer function 430 estimation. It is to be understood that any number of audio transfer function 430 estimates may be performed over the period of time. In some cases, when more than one audio transfer function 430 estimates are performed during the operations 300, the newest (or most recent) audio transfer function 430 estimate may replace (or update) the prior audio transfer function estimate. In other cases, multiple audio transfer function 430 estimates may be stored on the wearable audio device itself, and/or online in the cloud. For example, multiple audio transfer function estimates may be combined or averaged together to serve as the audio transfer function 430. In certain aspects, the operations 300 may be performed when the newest audio transfer function 430 estimate has a certain age (e.g., and should be updated) or when a threshold is crossed (e.g., when a coherence between the signals used for audio transfer function 430 estimation at block 330, in raw forms and/or processed forms, cross a certain threshold). In certain aspects, the operations 300 may be performed when the output audio signal 410 and/or the received audio signal 420 includes content in a frequency range of interest above a certain value (e.g., voltage level). In some cases, only a portion of the frequencies (or some of the frequency bands) of an audio transfer function 430 may be updated by the operations 300.

In certain aspects, the output audio signal 410 may include a signal for cancellation and/or a playback content input signal being output (e.g., played) via the driver of the wearable audio device. For example, the content being played on the wearable audio device may include at least one of audio playback content (e.g., music, movies, television shows, sport events, games, podcasts, or other similar entertainment) and/or aware mode content (e.g., sounds from the environment of the user). In certain aspects, the entirety of the playback content input signal may be considered (and/or referred to as) playback content input signal labeled “m₁” or playback content input signal labeled “m₂,” whereas in other cases, the playback content input signal may be split between the playback content input signal m₁ and the playback content input signal m₂ (e.g., to improve the control and results of the process flow 400). For example, the playback content input signal m₁ may include the lower frequency portion of the playback content input signal and the playback content input signal m₂ may include the higher frequency portion of the playback content input signal. In some cases, the playback content input signal m₁ may be injected into the command injection point, and/or the playback content input signal m₂ may be injected into the disturbance injection point, as illustrated in FIG. 4.

It is to be understood that the output audio signal 410 may refer to the entirety of the output audio signal 410 (including the playback content input signal and the signal for cancellation) or just the playback content input signal (without the signal for cancellation). In some cases, the playback content may originate from a source device (e.g., source device 120). The signal for cancellation may include, for example, feedback signals, feedforward signals, aware mode signals (e.g., sounds from the environment of the user), and/or sidetone (e.g., self-voice from the user).

According to certain aspects, the operations 300 may further include triggering the estimating, using the output audio signal and the received audio signal, of the audio transfer function 430 when a spectral density of the output audio signal is greater than a threshold. In this manner, the audio transfer function 430 estimation at block 330 may be performed when the output audio signal 410 is sufficiently spectrally dense enough to enable a quality estimated audio transfer function 430 to be produced, helping to make the operations 300 more robust to external noise (e.g., background sound other than the output audio signal 410 present in the received audio signal 420, labeled “nₛ”) in the received audio signal 420.

In some cases, estimating the audio transfer function 430 at block 330 may include using a direct method. The direct method may include estimating the audio transfer function 430 between the output audio signal 410 and the received audio signal 420. In this manner, two audio signals (e.g., the output audio signal 410 and the received audio signal 420) from inside the feedback loop (e.g., the feedback loop illustrated in FIG. 4) are utilized for estimating the audio transfer function 430 at block 330. As a result, and in some cases, a bias may be introduced into the audio transfer function 430 estimation at block 330 that may impact (e.g., corrupt) the estimate when outside noise is relatively high. The direct method may include relatively less computation compared to other methods. However, when using the direct method, the audio transfer function 430 estimation at block 330 may be more susceptible to external noise in received audio signal 420.

In other cases, estimating the audio transfer function 430 at block 330 may include may include using a first sensitivity method. The first sensitivity method may include one or more of (i) forming an adjusted audio signal (labeled “s′”) by summing the playback content m₁ (e.g., injected at the command injection point and used to produce the output audio signal 410) and the received audio signal 420 (e.g., using an adder 440), (ii) applying a feedback compensator 450 (labeled “K_{FB}”) to the adjusted audio signal, and (iii) estimating the audio transfer function 430 between the playback content input signal m₁ and the adjusted received audio signal. In these cases, the playback content input signal m₁ may include the entirety of the playback content input signal.

In yet other cases, estimating the audio transfer function 430 at block 330 may include may include using a second sensitivity method. The second sensitivity method may include estimating the audio transfer function 430 between the playback content input signal m₂ (e.g., injected at the disturbance injection point and used to produce the output audio signal 410) and the output audio signal 410. In these cases, the playback content input signal m₂ may include the entirety of the playback content input signal.

In yet other cases, estimating the audio transfer function 430 at block 330 may include may include using a third sensitivity method. The third sensitivity method may include estimating the audio transfer function 430 between a combination of the playback content input signal m₁ (e.g., injected at the command injection point) and the playback content input signal m₂ (e.g., injected at the disturbance injection point) and the output audio signal 410. The playback content input signal m₁ may include the lower frequency portion of the playback content input signal and the playback content input signal m₂ may include the higher frequency portion of the playback content input signal, and both the playback content input signal m₁ and the playback content input signal m₂ may be used to produce the output audio signal 410.

The first, second, and third sensitivity methods may involve using a signal from inside the feedback loop (e.g. output audio signal 410 or received audio signal 420) and another signal from outside the feedback loop (e.g., playback content input signal m₁ and/or m₂) for estimating the audio transfer function 430 at block 330. In this manner, the first, second, and third sensitivity methods may avoid the bias that may be produced when using the direct method when estimating the audio transfer function 430 at block 330. As a result, using the first, second, and third sensitivity methods may estimate the audio transfer function 430 more robustly (even if relatively high external noise is present), while using relatively more computation (e.g., compared to the direct method).

In certain aspects, the operations 300 may always utilize one of the direct method, the first sensitivity method, and the second sensitivity method to estimate the audio transfer function 430 at block 330, whereas in other aspects, the wearable audio device (or the operations 300) may select which of the direct method, the first sensitivity method, and the second sensitivity method to utilize, based, for example, on a user selection and/or processing/computation resources available on the wearable audio device.

In certain aspects, estimating the audio transfer function 430 at block 330 may include performing one or more signal processing techniques. In some cases, the one or more signal processing techniques may include a least means square algorithm, or any other digital signal processing technique.

At block 340, the operations 300 may include controlling, based on the estimated audio transfer function 430, one or more operations of the wearable audio device. Controlling the one or more operations may include controlling any controller or filter of the wearable audio device. In some cases, the one or more operations may include at least one of: the output of the output audio signal, an aware mode of the wearable audio device, an acoustic echo canceller of the wearable audio device (e.g., for handling self-voice from the user of the device and/or for audio calls), an active noise reduction mode, and/or any other modes or controllers of the wearable audio device. According to certain aspects, the output audio signal may be controlled by adjusting at least one of an audio limiter, a feedback controller (e.g., for feedback stability control), a feedforward controller, an aware mode controller, a voice filter, a sidetone filter, an audio equalizer, and/or any other controllers or filters of the wearable audio device.

According to certain aspects, the operations 300 may further include triggering the controlling, based on the estimated audio transfer function 430, of the one or more operations of the wearable audio device when a coherence between the output audio signal 410 (or playback content used to produce the output audio signal 410) and the received audio signal 420 is greater than a threshold. In this manner, the audio transfer function 430 estimation at block 330 may be used to control the one or more operations of the wearable audio device when the coherence between the output audio signal 410 and the received audio signal 420 is sufficiently high to provide a quality estimated audio transfer function 430, helping to make the operations 300 more robust to external noise in the received audio signal 420. In certain aspects, the cross-spectral density or other similar quality metric may be used as the basis for comparison between the output audio signal 410 and the received audio signal 420 (as opposed to the coherence). In some cases, certain frequencies (or frequencies ranges) of the output audio signal 410 and/or the received audio signal 420 may be used to determine the coherence, cross-spectral density, or other similar quality metric between the output audio signal 410 and the received audio signal 420.

### Additional Considerations

It is noted that, descriptions of aspects of the present disclosure are presented above for purposes of illustration, but aspects of the present disclosure are not intended to be limited to any of the disclosed aspects. Many modifications and variations will be apparent to those of ordinary skill in the art without departing from the scope and spirit of the described aspects.

In the preceding, reference is made to aspects presented in this disclosure. However, the scope of the present disclosure is not limited to specific described aspects. Aspects of the present disclosure can take the form of an entirely hardware aspect, an entirely software aspect (including firmware, resident software, micro-code, etc.) or an aspect combining software and hardware aspects that can all generally be referred to herein as a “component,” “circuit,” “module” or “system.” Furthermore, aspects of the present disclosure can take the form of a computer program product embodied in one or more computer readable medium(s) having computer readable program code embodied thereon.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples of a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium can be any tangible medium that can contain, or store a program.

The flowchart and block diagrams in the Figures illustrate the architecture, functionality and operation of possible implementations of systems, methods and computer program products according to various aspects. In this regard, each block in the flowchart or block diagrams can represent a module, segment or portion of code, which comprises one or more executable instructions for implementing the specified logical function(s). In some alternative implementations the functions noted in the block can occur out of the order noted in the figures. For example, two blocks shown in succession can, in fact, be executed substantially concurrently, or the blocks can sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

1. A wearable audio device of a user comprising:
a driver;
a sensor; and
one or more processors being configured, individually or collectively, to:
output, using the driver, an output audio signal;
receive, using the sensor, a received audio signal;
estimate, based on the output audio signal and the received audio signal, an audio transfer function at least periodically over a period of time; and
control, based on the estimated audio transfer function, one or more operations of the wearable audio device when at least one of a spectral density of the output audio signal is greater than a first threshold or a coherence between the output audio signal and the received audio signal is greater than a second threshold.

2. The wearable audio device of claim 1, wherein the audio transfer function comprises an on-head transfer function.

3. The wearable audio device of claim 1, wherein the period of time comprises a time between a first power cycle of the wearable audio device and a second power cycle of the wearable audio device.

4. The wearable audio device of claim 1, wherein the one or more processors are configured, individually or collectively, to estimate the audio transfer function continuously over the period of time.

5. The wearable audio device of claim 1, wherein the output audio signal comprises at least one of audio playback content or aware mode content.

6. The wearable audio device of claim 1, wherein the one or more processors are configured, individually or collectively, to estimate, based on the output audio signal and the received audio signal, the audio transfer function when at least one of the spectral density of the output audio signal is greater than the first threshold or when the coherence between the output audio signal and the received audio signal is greater than the second threshold.

7. The wearable audio device of claim 1, wherein the one or more processors are configured, individually or collectively, to control, based on the estimated audio transfer function, the one or more operations of the wearable audio device when the spectral density of the output audio signal is greater than the first threshold and when the coherence between the output audio signal and the received audio signal is greater than the second threshold.

8. The wearable audio device of claim 1, wherein the sensor comprises a bone conduction sensor.

9. The wearable audio device of claim 8, wherein the bone conduction sensor comprises one of: an internal microphone disposed inside an ear canal of the user, a microphone facing the ear canal, a voice band accelerometer disposed outside the ear canal, an inertial measurement unit (IMU), or a feedback microphone.

10. The wearable audio device of claim 1, wherein the one or more operations comprise at least one of:
the output of the output audio signal;
an aware mode of the wearable audio device;
an acoustic echo canceller of the wearable audio device; or
an active noise reduction mode of the wearable audio device.

11. The wearable audio device of claim 10, wherein the one or more processors are configured, individually or collectively, to control the output audio signal by adjusting at least one of an audio limiter, a feedback controller, a feedforward controller, an aware mode controller, a voice filter, a sidetone filter, or an audio equalizer of the wearable audio device.

12. The wearable audio device of claim 1, wherein to estimate the audio transfer function, the one or more processors are configured, individually or collectively, to estimate the audio transfer function between the output audio signal and the received audio signal.

13. The wearable audio device of claim 1, wherein to estimate the audio transfer function, the one or more processors are configured, individually or collectively, to:
form an adjusted audio signal by summing an input audio signal corresponding to the output audio signal and the received audio signal; and
estimate the audio transfer function between the output audio signal and the adjusted received audio signal.

14. The wearable audio device of claim 1, wherein to estimate the audio transfer function, the one or more processors are configured, individually or collectively, to perform one or more signal processing techniques.

15. A method comprising:
outputting, using a driver included in a wearable audio device, an output audio signal;
receive, using a sensor included in the wearable audio device, a received audio signal;
estimate, based on the output audio signal and the received audio signal, an audio transfer function at least periodically over a period of time; and
control, based on the estimated audio transfer function, one or more operations of the wearable audio device when at least one of a spectral density of the output audio signal is greater than a first threshold or a coherence between the output audio signal and the received audio signal is greater than a second threshold.

16. The method of claim 15, wherein the period of time comprises a time between a first power cycle of the wearable audio device and a second power cycle of the wearable audio device.

17. The method of claim 15, wherein the output audio signal comprises at least one of audio playback content or aware mode content.

18. A non-transitory computer-readable medium comprising computer-executable instructions that, when executed by one or more processors of a wearable audio device, cause the wearable audio device to perform a method, the method comprising:
outputting, using a driver included in a wearable audio device, an output audio signal;
receive, using a sensor included in the wearable audio device, a received audio signal;
estimate, based on the output audio signal and the received audio signal, an audio transfer function at least periodically over a period of time; and
control, based on the estimated audio transfer function, one or more operations of the wearable audio device when at least one of a spectral density of the output audio signal is greater than a first threshold or a coherence between the output audio signal and the received audio signal is greater than a second threshold.

19. The non-transitory computer-readable medium of claim 18, wherein the period of time comprises a time between a first power cycle of the wearable audio device and a second power cycle of the wearable audio device.

20. The non-transitory computer-readable medium of claim 18, wherein the output audio signal comprises at least one of audio playback content or aware mode content.
